(19) United States
(12) Patent Application Publication
(10) Pub. No.: US 2007/0044066 A1
(43) Pub. Date: Feb. 22, 2007

(54) Embedded multi-language programming

(75) Inventors: Henricus Johannes Maria Meijer, Mercer Island, WA (US); Brian C. Beckman, Newcastle, WA (US); Avner Y. Aharoni, Seattle, WA (US); David N. Schach, Redmond, WA (US); Peter F. Drayton, Redmond, WA (US); Ralf Lammel, Redmond, WA (US); Jose A. Blakeley, Redmond, WA (US); Cyrus Najmabadi, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/208,228

(22) Filed: Aug. 19, 2005

(51) Int. Cl. G06F 9/44

(52) U.S. Cl. 717/100; 717/101; 717/114

(57) ABSTRACT

Multiple programming languages can be embedded and supported within a single source. Programs nested with syntax from a plurality of languages (e.g., C#, SQL, XML . . . ), among other things, enable users to avail themselves of advantageous aspects of different languages for particular tasks. Language services that provide language specific functionality including but not limited to formatting, intelligent assist, auto completion, and coloring, can be employed and switched between to afford support for their respective languages in a mixed language source program. Similarly, mixed language programs can be compiled with language specific services or systems such as parsers, scanners and the like to process corresponding code portions.

### BACKGROUND

Computer programmers create computer programs by editing source code files and passing these files to a compiler program to create computer instructions executable by a computer or processor-based device. In the early days, this task was most commonly accomplished by using several unrelated command-line utilities. For example, the source code files are written using a text editor program. The source code files are compiled into object code files using a separate compiler program. A linker utility, sometimes a part of the compiler program, combines the object code files into an executable program. Larger software projects may require a build-automation utility to coordinate the compiling and linking stages of the software build. A separate debugger program may be used to locate and understand bugs in the computer program.

An Integrated Development Environment (IDE) is computer software adapted to help computer programmers develop software quickly and efficiently. An IDE provides features to create, modify, compile, deploy, and debug computer programs. An IDE normally consists of a source code editor, a compiler or interpreter, build-automation utilities, and a debugger tightly integrated into a single application environment. Modern IDEs often include a class browser and an object inspector to assist in object-oriented development with a programming language such as C# or Java. Some IDEs also include the capability to interface with a version control system such as CVS or Visual SourceSafe or various tools to facilitate the creation of a graphical user interface (GUI).

An IDE offers a quick and efficient way to develop computer software. Learning a new programming language becomes easier through the use of an IDE since the details of how component parts piece together is handled by the IDE itself. The tight integration enables greater productivity since different steps of the development process can happen concurrently and/or automatically. For example, source code may be compiled in the background it is being written, thus immediately providing feedback such as syntax errors. This integration also allows for code completion features so that the IDE can provide the programmer with valid names for various elements of the language based on the initial input of the programmer, thus reducing the time spent reviewing documentation.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the disclosed subject matter concerns computer programming and support for mixed-mode or multi-language sources. Rather than source code being written solely in a single language, code specified in multiple languages can be embedded within the source. By way of example and not limitation, the source could include Visual Basic, XML, and SQL code. Furthermore, the integrated development environment can support such mixed code and provide proper intelligent assistance or hinting, automatic statement completion, and formatting (e.g., pretty print, colorizing . . . ), among other things. Additionally, the multi-language sources can be correctly scanned, parsed, type checked, and compiled utilizing language specific information and services. Such functionality can be provided by, among other things, aggregating language service providers or components.

A new mixed language service component is disclosed herein to enable service provider aggregation. The mixed language service component can interact with an IDE just like any other language service component. However, the mixed mode language service component can also host a plurality of language specific service components. The mixed language service component can cooperate with and coordinate, recursively, with a plurality of language service components. More specifically, the mixed language service component can coordinate switching amongst particular language service components to ensure that the appropriate services are employed with respect to their associated languages. Switching can be performed upon detection of language boundaries.

Language boundaries can be detected either explicitly or implicitly. For example, languages can be extended to support quasi quote marks or mechanisms. Such symbols can be included in the language to specify a language boundary. Detection of the boundary is a matter of simply detecting the designated symbol. When language boundaries are not explicitly specified, they can be inferred based on surrounding context.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a computer programming system.

FIG. 2 is an exemplary graphical user interface associated with an integrated development environment.

FIG. 3 is a block diagram of a mixed language service component.

FIG. 4 is a block diagram of a system to detect language boundaries.

FIG. 5 is a block diagram of an exemplary multi-language source.

FIG. 6 is a block diagram of a mixed language interface system.

FIG. 7 is a flow chart diagram of a method of interacting with multi-language code.

FIG. 8 is a flow chart diagram of method of interacting with embedded mixed language code.

FIG. 9 is flow chart diagram of a method of switching language services.

FIG. 10 is a flow chart diagram of a method of parsing multi-language source.

FIG. 11 is a schematic block diagram of an exemplary compilation environment.

FIG. 12 is a schematic block diagram illustrating a suitable operating environment.

FIG. 13 is a schematic block diagram of a sample-computing environment.

### DETAILED DESCRIPTION

The various aspects of the subject invention are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system,” “environment” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, jump drive . . . ). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

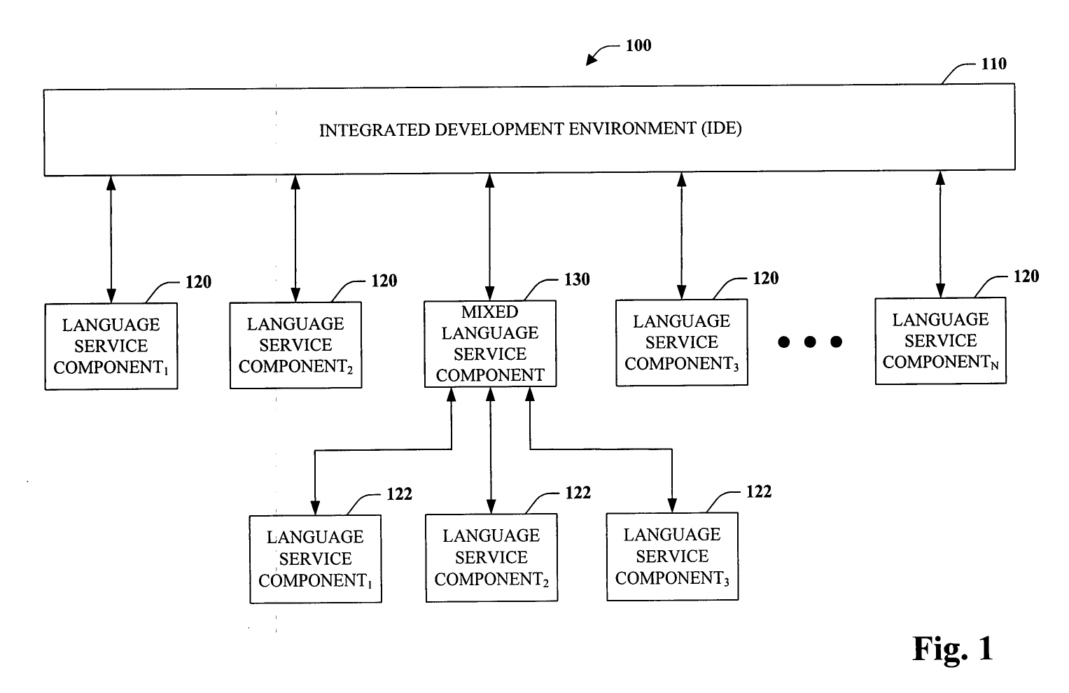

Turning initially to FIG. 1, a computer system 100 to facilitate computer programming is depicted. System 100 includes an integrated development (or design) environment 110, a plurality of language service components (1 to N, where N is an integer greater than one) 120 and 122, as well as a mixed language service component 130. The integrated development environment 110 provides a user-friendly graphical interface to facilitate program specification, building and/or compiling, and debugging, among other things. The IDE 100 is basically a collection of tools that make it easier for a programmer to program. Moreover, alone, the IDE 100 is language agnostic. IDE 110 interacts with one or more language service components 120 to support specific programming languages.

Language service components 120 provide language specific knowledge and services to the IDE. By way of example and not limitation the language service components 120 can correspond to programming languages such as Visual Basic, C, C++, C#, and Java, data representation languages like XML (Extensible Markup Language), and query languages such as SQL (Structured Query Language) and XPath or XQuery. The language services components 120 can include specific information and services related to a particular language. In one instance, the language service components 120 can include information pertaining to intelligent assistance or hinting, auto-completion, format and colorization (i.e., pretty print), among other things. Furthermore, the service components 120 may also include a language grammar and type system as well as system software components, including but not limited to a scanner, parser, type checker, and compiler.

The language service components 120 are interfaced with the IDE 110. Each service component 120 can implement its own set of interfaces and the IDE 110 communicates with each language service via these provided interfaces. What is common amongst the language service components 120 is the environment and functionality provided thereby including but not limited to widow frames, menu layouts, the overall approach of intelligent hinting, project structure, and tree-control views. However, language service components 120 are unaware of each other's presence and interaction with the IDE 110. Each service component is hosted separately by the IDE 110. Being hosted means, among other things, that the IDE 110 can supply the language service component 120 with text as the user types it, and the service component 120 can furnish intelligent hinting, rewrite the text to screen with a pretty print and colorizer. Furthermore, the language service component 120 aid in auto-completion (e.g., matching parentheses, filing out “End . . . ” statements . . . ), resolving ambiguities and typos, inter alia. Each language service component can provide such assistance for their particular language. Thus, the IDE 110 in conjunction with a language service component 120 can provide an editing environment or world for one specific language.

The mixed language service component 130 is different from language service components 120. Although hosted by or interface with IDE 110 like language service components 120, mixed-language service component 130 interacts with and manages a plurality of language service components 122 to enable multiple programming languages or subsets thereof to be mixed and supported in the same source file, for example. The mixed-language service component 130 can be viewed by the IDE 110 as just another language service provider, such as components 120. Accordingly, the IDE 110 can interact with the mixed language service component 130 just as it would with language service components 120. Language service components 122 can be another instance of corresponding language service components 120. Language service components 122 are communicatively coupled to the mixed-language component 130. Moreover, service components 122 can simply view the mixed-language service component 130 as an IDE. The mixed-language service component 130 can coordinate switching or recursive switching between two or more languages service components 120 corresponding to Visual Basic, XML, and SQL to name but a few. The language service components 122 can remain largely unchanged from corresponding components 120. However, they can be extended. For instance, the languages and thus the language service components 122 can be modified to include markers for delineating a language scope. By way of example and not limitation, a host language can be extended with a (quasi) quote mechanism to signal transition to embedded languages. Additionally or alternatively, embedded languages can be extended to support an unquote mechanism to escape back to the host language. Furthermore, the embedded languages must be receptive to and able to request context information from the host language such as a symbol table and type information.

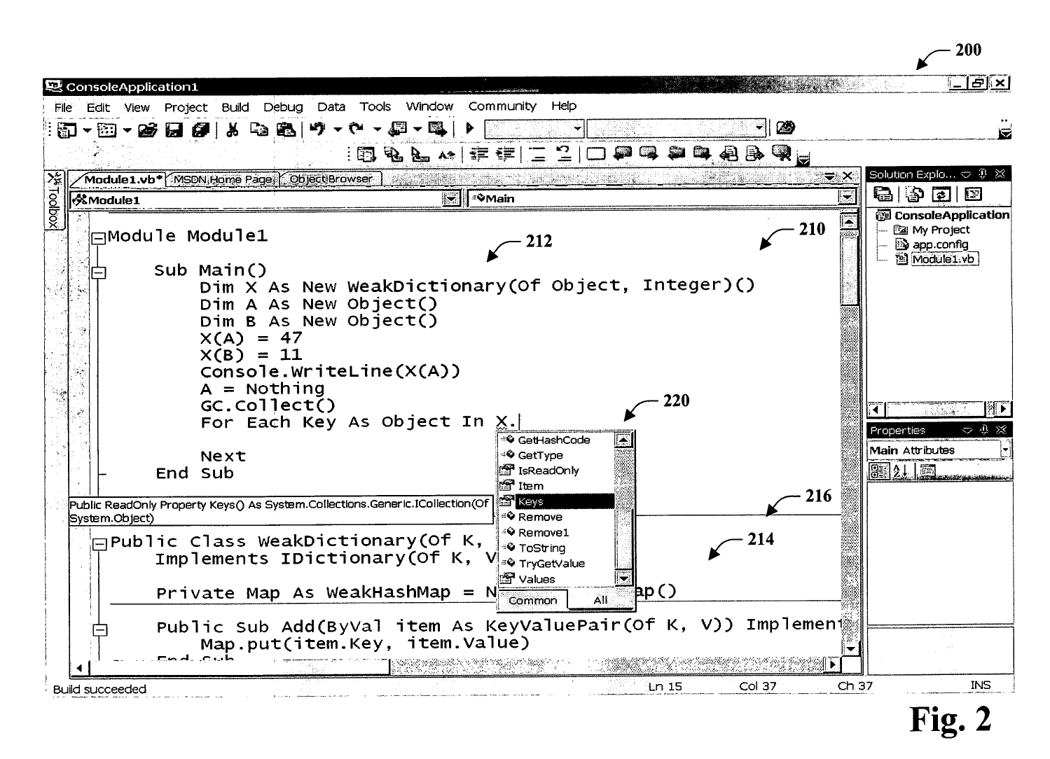

Turning briefly to FIG. 2 an exemplary graphical user interface 200 associated with IDE 110 is shown. Interface 200 includes a plurality of window frames and menus common to all language providers or components. Additionally, interface 200 provides a code-editing window 210 for display and specification of code. In this instance, two types of code can be provided in the same source Visual Basic 212 and C# 214. For easy reference, a box 216 or other mechanism can be utilized to partition code of different languages. Furthermore, the exemplary interface 200 illustrates a drop down menu 220 that can provide intelligent hinting or assistance by displaying selectable code based on context.

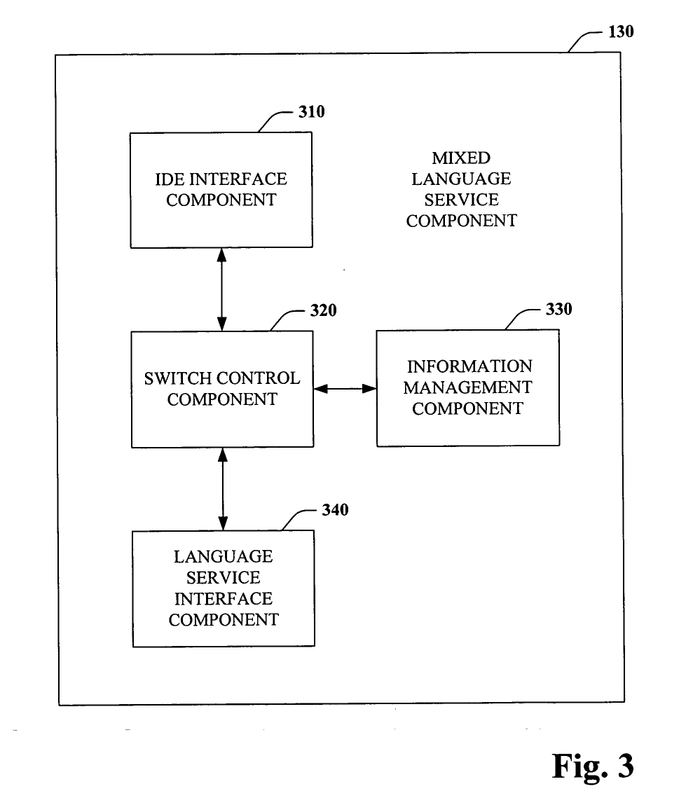

FIG. 3 illustrates a mixed-language service component 130 in further detail. Service component 130 can include IDE interface component 310, switch control component 320, information management component 330 and language service interface component 340. IDE interface component 310 provides a mechanism to enable communication between an IDE and the mixed-language component 130. For example, the component 310 may implement a plurality of interfaces that the IDE can employ to request and retrieve information or initiate services. Switch control component 320 is communicatively coupled to the IDE interface component 310 and can process IDE requests. Based on context information, for example, switch control component 320 can delegate requests to particular language service components 122 (FIG. 1). Switch control component 320 can communicate with service components via language service interface component 340. Service interface component 340 can be communicatively coupled to the switch component as well as one or more language service components 122 (FIG. 1) such that information can be requested and/or processes initiated by the switch control component 320. Mixed language service component 130 can also include information management component 330 communicatively coupled to switch control component 320. Information management component 330 can store and retrieve language related information. The switch component 320 can interact with the information management component 330 to, among other things, store information to facilitate recursive coordination of a number of language service components. For instance, the information management component 330 can maintain a stack from which language identifying information can be pushed and popped to control recursion. Furthermore, switch component 320 can cooperate with information management component to store and provide context information to and from various languages such type information and a symbol table. For instance, a host language may need context information from one or more host languages to determine a type.

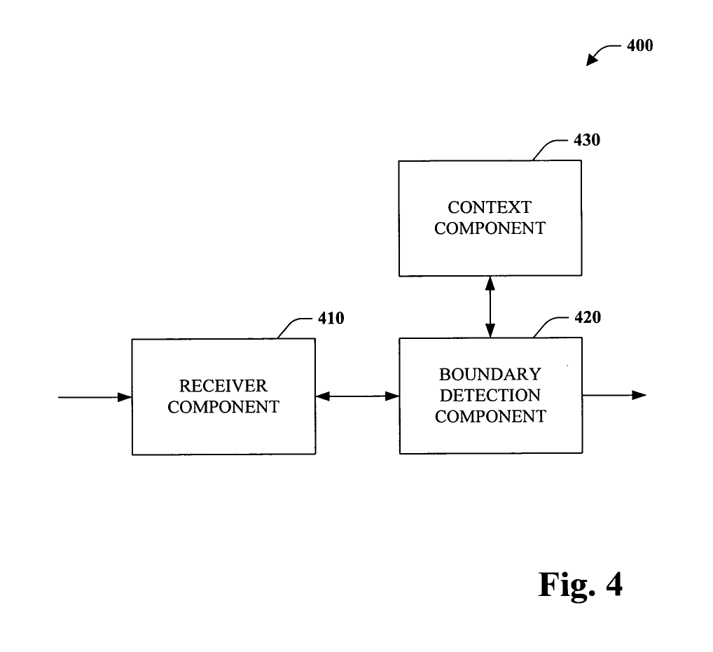

FIG. 4 depicts a system 400 for detecting code boundaries or regions. System 400 can include a receiver component 410, a boundary detection component 420 and a context component 430. System 400 can be executed by a mixed-language service component 130 and/or a language service component 122 of FIG. 1, amongst other components. Receiver component 410 receives, retrieves or otherwise obtains language text, for example from an editor or buffer associated therewith. Such text is provided to or retrieved by boundary detection component 420, which is communicatively coupled to receiver component 410. Boundary detection component 420 analyzes the code or text to detect boundaries or regions of language code. Boundary detection component 420 can detect boundaries by identifying explicit markings or utilizing context information provided by context component 430.

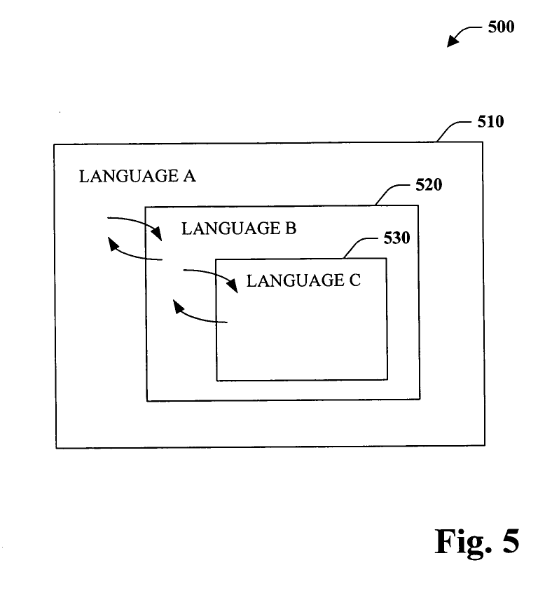

Turning briefly to FIG. 5, an exemplary multi-language source 500 is depicted to facilitate clarity and understanding. It should be appreciated that multi-language source 500 presents only one of an almost infinite number of ways languages can be embedded, and is therefore not meant to limit the scope of the claimed subject matter in any way. As illustrated, there are three languages or language subset A 510, B 520 and C 530 represented graphically as blocks. Language B 530 is embedded within language A 510 and language C 530 is embedded within language B 520. For example, language A 510 could be Visual Basic, language B 510 could be C#, and language C 530 could be SQL or even Visual Basic again. Thus, there are multiple layers of language embedding which can be processed recursively, for example. However, prior to processing the differing language regions need to be identified. In particular, the boundaries between language A 510 and language B 520 as well as the boundary between language B 520 and language C 530 should be detected.

Returning to FIG. 4, boundary detection component 420 can identify boundaries based on detection of explicit marks or markings. Programming languages can be extended to support quasi quote and unquote mechanisms, where the quote mechanism signals a transition forward to an embedded language and the unquote mechanism signals escape back to a host language. The specific combinations of syntax can be almost anything as long as boundaries can be clearly identified, for example, “SQL[ . . . ],” where the language between the brackets is SQL, or [% . . . %] which denotes that an embedded language again between the brackets. Furthermore, the marking can be much more subtle such as a comma to denote a transition. The quote, unquote mechanism can even be implicit. Accordingly, the quote, unquote or both mechanisms need not be explicitly specified if a boundary can otherwise be detected.

Context component 430 can analyze the received code or text and provide boundary detection component 430 context information to enable boundary detection component 430 to accurately infer a boundary. For instance, identification of literals in the form <value> . . . </value> in a programming language can be utilized to detect boundaries. Consider the following example:

```
Dim x = <Book>
    <Author> John Doe </Author>
    <Title> Cooking for Amateurs </Title>
  </Book>
```

Here, just two languages are represented—Visual Basic and XML. Up on analyzing the syntax it can be identified that “Dim x=” is Visual Basic syntax. Then, a book is specified as “<Book> . . . </Book>, so boundary detection component can infer from the context that there is a boundary between languages after the equal “=” sign.

Another example of quoting can be appreciated with respect to creating expression trees, for instance in C#. The C# mechanism for creating expression trees utilizes a combination of lexical quoting via the lambda syntax “|args| expr” and implicit type conversion from the “type” of a lambda expression to Expression<T>. The embedded language is a proper subset of the host language. For instance:

int = 4711;
Expression<Func<int, int>> = |x| x*y;

Here, the unquote can be inferred because “y” is a free variable. In particular, the unquote is implicit and implemented by a thunk or funclet process that uses context information about free variables inside the lambda expression that are defined in an enclosing host language. When embedding SQL, quasi quote and unquote are implicit as well:

Dim Limit = 42;
Dim Xs = Select C.Name, C.Age From C In
Customers Where C.Age > Limit;

Still another example of quoting is to user semantic delimiters based on a host language. For instance:

using System.Text.RegularExpression;

...
Regex r = new Regex(“......”);

With the appropriate “using” this becomes a location where one can embed an appropriate regex language service provider, but remove the using and suddenly the hosting goes away. That is because in this case the language service provider is employed to say for anything that binds to the constructor for “System.Text.RegularExpression.Regex” new language support should be added. The code in the quotes can be, but does not have to be, a string. It could be interpreted as a variable by some language service that knows how to edit regular expressions.

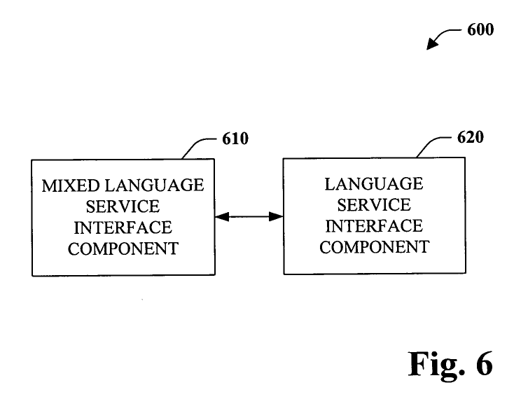

Turning to FIG. 6 an interface system 600 is depicted. System 600 facilitates communication between a mixed language service component and at least one language specific service component. Interface system 600 includes a mixed language service interface component 610 and a language service interface component 620. Mixed language service interface component 610 can interact with a mixed language service component that coordinates and cooperates with one or more language service components. Mixed interface component 610 is communicatively coupled to language service interface component 620. Language service interface component 620 can interact with a language specific service component. Interface component 620 can implement a plurality of interfaces that can be called by interface component 610. Likewise, interface component 610 can implement a plurality of interfaces that can be employed by interface 620. Accordingly, interface component 610 can facilitate request of language specific information, passing of data or initiation of language specific processes (e.g., scanning, parsing, type checking, compilation . . . ) and the interface 620 can transmit responses to the requests of interface component 610 where applicable. Transmission of data between interface component 610 and interface component 620 can be via data packets over any means of computer communication.

While there has been discussion about the ability to embed one language within another, it should be appreciated that the subject systems above and methods provided below can support embedding of just a subset of one language within another. For example:

```
class CSharpClass
{
  void ACSharpMethod( )
  {
  }
  //--VB Begin
  Sub VBMethod( )
    Dim HeyNeat As ImEmbeddingAVBMethodInCSharp
  End Sub
  //--VB End
}
```

In order to provide this level of integration it should be noted that while it appears that only a single method of VB is being displayed here, it is possible that what is being displayed is only a view over the actual embedded code. In actuality, the VB existing code could look like:

```
Module EmbeddedVBModule
    Sub VBMethod( )
      Dim HeyNeat As ImEmbeddingAVBMethodInCSharp
    End Sub
End Module
```

Therefore, the “Module” portion exists within the embedded language service, but is does not surface in any visible way to the user.

Furthermore, as the embedded language service is only accessible to the user through a view, the architecture or system can support the ability for hosted language services to be able to determine that they are in fact hosted, for example by mixed language service 130 of FIG. 1, so that they can determine what users can see and thus act accordingly. They might also need this information as it might affect the behavior of there features. By way of example and not limitation, consider the following code snippet:

```
using System;
class CSharpClass
{
  void ACSharpMethod( )
  {
  }
  //--VB Begin
  Sub VBMethod( )
    Dim HeyNeat As ImEmbeddingAVBMethodInCSharp
    Dim start as DateTime
  End Sub
  //--VB End
}
```

Here, “using System” is added and enables “VBMethod” to utilize elements from “System.” Likewise, VB could have a feature whereby you could add a “using” for an unbound type and one would expect it to communicate that information to the hosting language so that appropriate action could be taken. For instance:

```
class CSharpClass
{
  void ACSharpMethod( )
  {
  }
  //--VB Begin
  Sub VBMethod( )
    Dim HeyNeat As ImEmbeddingAVBMethodInCSharp
    Dim start as StringBuilder ’ use a VB feature to try to add: “Imports
System.Text”
  End Sub
  //--VB End
}
When doing this, the end effect would be to have:
using System.Text;
class CSharpClass
{
  void ACSharpMethod( )
  {
  }
  //--VB Begin
  Sub VBMethod( )
    Dim HeyNeat As ImEmbeddingAVBMethodInCSharp
    Dim start as StringBuilder ’ use a VB feature to try to add: “Imports
System.Text”
  End Sub
  //--VB End
}
```

Accordingly, while a hosted language can be oblivious to its situation, it is also possible for it to get a full understanding of the system and to enable communication, for example through mixed language service 130, with every language service participating in a multi-language service system.

The aforementioned systems have been described with respect to the interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components and/or sub-components may be combined into a single component providing aggregate functionality. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. For example, boundary detection component 420 could utilize artificial intelligence, machine learning or like mechanisms to facilitate identification of language boundaries.

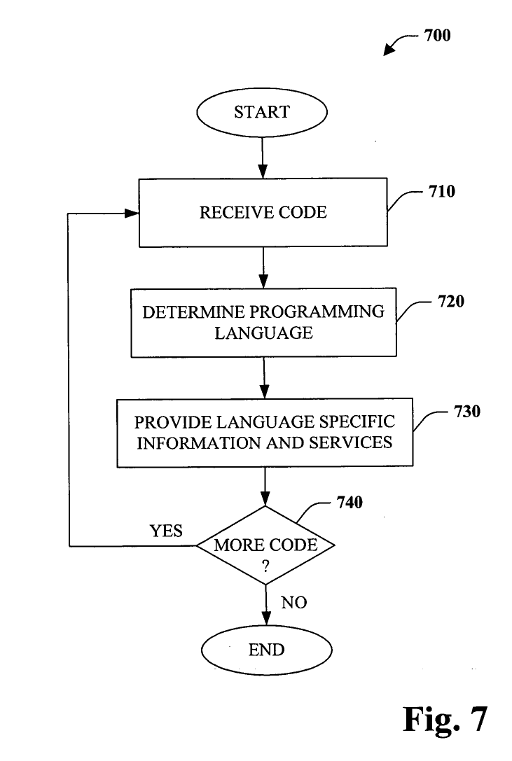

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Turning to FIG. 7, a method 700 of interacting with multi-language code is illustrated. At reference numeral 710, code is received, for example from an IDE, editor or buffer associated therewith. The code can be mixed-mode or multi-language code, for instance. At numeral 720, the programming language of the code is determined. At 730, language specific information and/or services are provided for the particular language, for example, intelligent hinting or assistance, auto-completion, scanning, parsing, type checking and the like can be provided or made available for use. At reference numeral 740, a determination is made as to whether all coded has been received or if there is more. If there is more code, then the method proceeds to 710 where the code is received. At 720, the language is determined and at 720 language specific information and/or services are provided. The method continues until all codes as been received at which point the process terminates. The cyclic nature of method 700 allows continuous monitoring of received code as well as causing language information and/or services to become available for a particular code language.

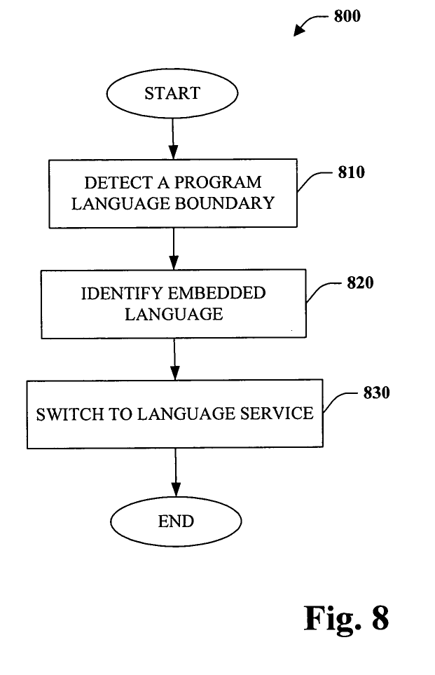

FIG. 8 is a flow chart diagram of a method 800 of interacting with embedded mixed language code. At reference numeral 810, a program language boundary is detected. A program language boundary corresponds to a point at which there is a language change from a first language to a second language, for instance. The boundary can be detected via explicit and/or implicit quoting, among other ways. A program can include an explicit mechanism such as a marker or set of markers that indicate a language boundary. In this case, detection can simply entail identification of such a marker or set of markers. Additionally or alternatively, a language boundary can be detected or inferred based on context. At 820, the embedded language is identified. Such identification can similarly be obtained explicitly from a marker or set of markers including but not limited to “SQL[ . . . ]” and/or implicitly from context, for example from “<Books> . . . </Books>” the language can be determined to be XML or from “Select . . . From . . . Where . . . ” it can be ascertained that the language is SQL. At reference numeral 830, a language service can be switched, for example, from the service corresponding to the language of the host to that of the identified embedded language. The language service can provide language specific information and/or processes including intelligent assistance, auto completion, scanning, parsing, type checking, and compiling, amongst other things. By switching language services, the support can be provided for an embedded language, for example, intelligence assistance, statement completion and the like can be provided for the embedded language rather than from a host language or not at all. Furthermore, the services can be language specific such that a parser, compiler and the like can be executed on a particular portion of code that is specified in the language associated with the service.

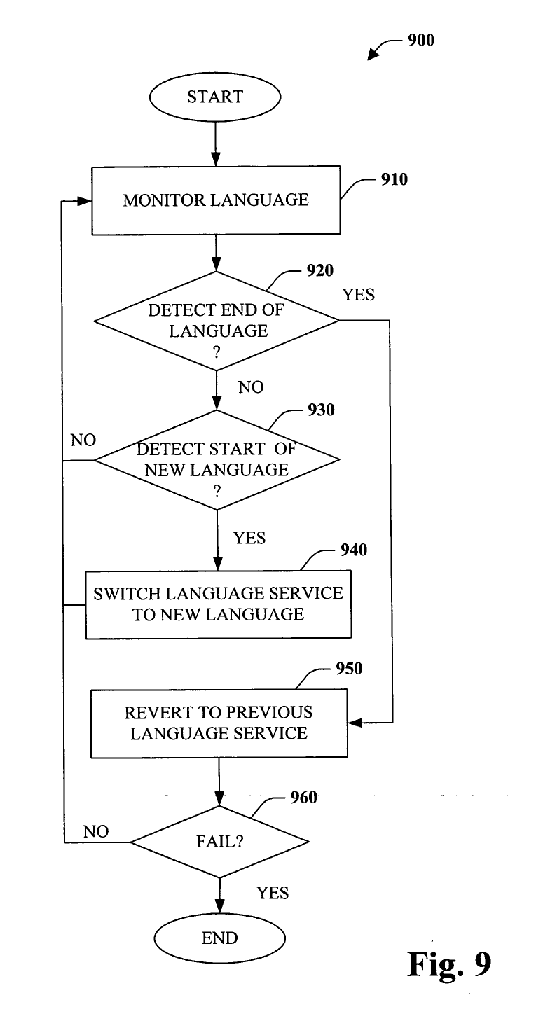

FIG. 9 depicts a method 900 of switching language services. At reference numeral 910, a language is monitored or analyzed. At 920, a determination is made as to whether the end of a language or language syntax has been detected. If it has, then the method can proceed to action 950 where the present language service is reverted to a previous language service. If a 960, this reversion fails perhaps because there is not a previous language service to revert to then the method terminates. Alternatively, the method proceeds to 910, where the language is monitored. If at reference numeral 920, the end of a language or language syntax is not detected then the method proceeds to 930. At 930, a determination is made as to whether the start of a new language is detected. For example, a language can be embedded within a host language and the boundary is detected. If at 930, the start of a new language has not been detected then the method continues at 910. Otherwise, the method proceeds to 940. Since a new language has been detected, at 940 the language service is switched to the service of the new language. Previously, it would be that of the host language. Subsequently, the method can continue at 910 where the language is monitored.

To more completely understand the nature of method 900, consider the following abstract example where there are three embedded languages in the form: “language A “language B ‘language C”’,” where language B is embedded in language A and language C is embedded in language B. To start, language A will be monitored at 910. At 920, a determination is made as to whether the end of the language has been detected. Since, language A is the host language the language does not end until end of the entire statement. Accordingly, the end has not been detected. The method proceeds to 930, where a determination is made as to whether the start of a new language has been detect. Assuming, language B is detected, the method continues at 940, where there is a language service switch to the service that corresponds to language B rather than A. The method carries on at 910, where the language is monitored and then at 920, a determination is made as to whether the end of the language has been detected. It has not, since language B includes embedded language code. At 930, a determination is made as to whether a new language has been detected. Assuming language C is detected, the language service is switched to the service corresponding to language C rather than B. The method proceeds to 910 where the language is monitored. At 920, a determination is made as to whether the end of the language is detected. Assuming, the end of language C is detected, the method advances to 950, where the language service is revered back to language B from C. A determination is made as to whether this reversion fails at 960. It did not so the method proceeds to 910 where the language is monitored and then to 920 where it is questioned as to whether the end of the language is detected. Assuming the end of language B is detected, the method continues to 950 where the language service is reverted to the service corresponding to language A. The method advances to 910 and then 920, where assuming the end of language A is detected, as the end of the statement is detected, the method proceeds to try to revert to a previous language service. Since, language A is the base language the reversion will fail at 960 and the method will terminate. As shown by this example, the language switching can be recursive such that multiple embedded language layers can be easily and efficiently supported.

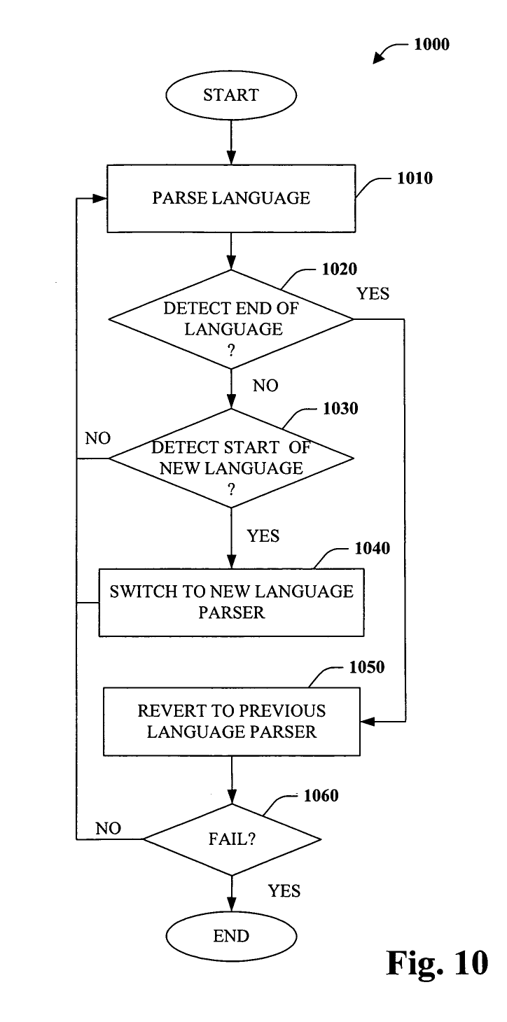

It should be appreciated that since language services associated with particular languages are switched so are all the services provided thereby. In addition to providing intelligent assistance, auto completion and the like for specific languages during program specification. Services can also include scanning, parsing, type checking, compiling, code generation and the like. For example, an IDE may receive a command to compile a program, the IDE then provides an indication of this to the mixed language service component, which can then coordinate, and switch hosted language service components to ensure that the appropriate compiler or information pertaining to compilation is employed for each particular language in a mixed language source. Accordingly, such services and the switching related thereto can also be recursive in nature although it does not have to be. FIG. 10 is provided to illustrate how the method of FIG. 9 can be modified to support services. For purposes of brevity, the method associated with each language services is not described, although, it should be appreciated that the method of FIG. 9 can be similarly modified to support other services provided by a language service component.

Turning to FIG. 10, a method 1000 of parsing a multi-language source is illustrated. At 1010, a language can be parsed utilizing a parser associated with a language service component for a base or host language. At 1020, a determination is made as two whether the end of the language is detected, at 1020. If yes, an attempt can be made to revert to a previous language parser 1050. If the reversion attempt is successful, the method continues at 1010 where language code is parsed. If the reversion attempt fails, the method terminates. If, at 1020, the end of a language is not detected, a determination is made at 1020 as to whether the start of a new language is detected, for example upon detection of explicit marker or via inference from context. If no, the method continues at 1010 where the language continues to be parsed. If the start of a new language is detected, then at 1040 a switch is made to another parser associated with the newly detected language. The method then advances to 1010, where the language is parsed with the new language. Parsing can continue until an attempt to revert to the previous language parser fails. In this instance, processing of the base or host language is complete therefore there are no previous parsers that can be called. In the end, parse trees from different languages can be linked together recursively.

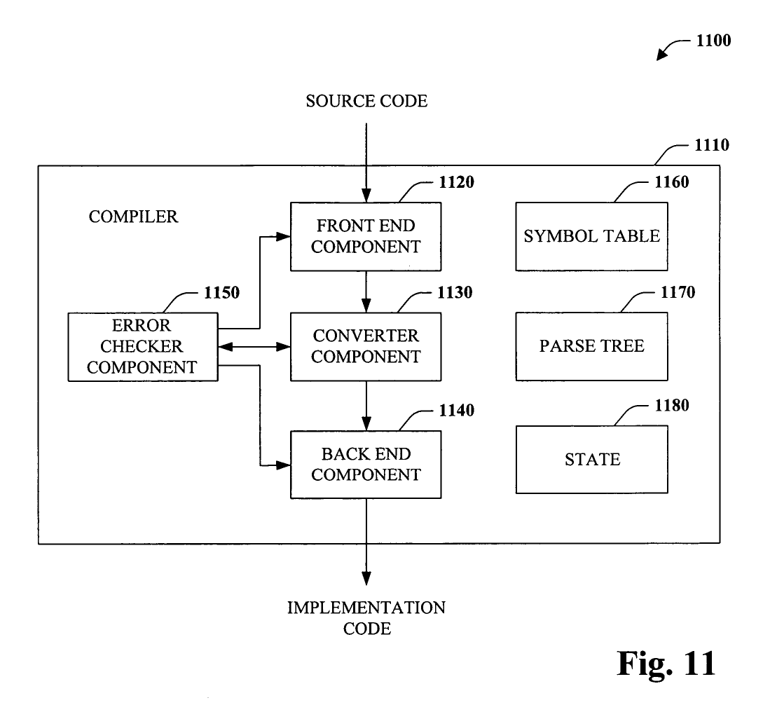

FIG. 11 is a block diagram depicting a compiler environment 1100 that can be utilized in conjunction with various systems, methods, and components provided herein including but not limited to the IDE 110 (FIG. 1) and/or various languages service components 120 and 122. In particular, compiler environment 1110 can produce implementation code (e.g., executable, intermediate language . . . ). The compiler environment 1100 includes a compiler 1110 including front-end component 1120, converter component 1130, back-end component 1140, error checker component 1150, symbol table 1160, parse tree 1170, and state 1180. The compiler 1110 accepts source code as input and produces implementation code as output. The input can include but is not limited to delimited programmatic expressions or qualified identifier as described herein. The relationships amongst the components and modules of the compiler environment illustrate the main flow of data. Other components and relationships are not illustrated for the sake of clarity and simplicity. Depending on implementation, components can be added, omitted, split into multiple modules, combined with other modules, and/or other configurations of modules.

Compiler 1110 can accept as input a file having source code associated with processing of a sequence of elements. The source code may include, for example, mixed or multi-language code. Compiler 1110 may process source code in conjunction with one or more components for analyzing constructs and generating or injecting code.

A front-end component 1120 reads and performs lexical analysis upon the source code. In essence, the front-end component 1120 reads and translates a sequence of characters (e.g., alphanumeric) in the source code into syntactic elements or tokens, indicating constants, identifiers, operator symbols, keywords, and punctuation among other things.

Converter component 1130 parses the tokens into an intermediate representation. For instance, the converter component 1130 can check syntax and group tokens into expressions or other syntactic structures, which in turn coalesce into statement trees. Conceptually, these trees form a parse tree 1170. Furthermore and as appropriate, the converter module 1130 can place entries into a symbol table 1160 that lists symbol names and type information used in the source code along with related characteristics.

A state 1180 can be employed to track the progress of the compiler 1110 in processing the received or retrieved source code and forming the parse tree 1170. For example, different state values indicate that the compiler 1110 is at the start of a class definition or functions, has just declared a class member, or has completed an expression. As the compiler progresses, it continually updates the state 1180. The compiler 1110 may partially or fully expose the state 1180 to an outside entity, which can then provide input to the compiler 1110.

Based upon constructs or other signals in the source code (or if the opportunity is otherwise recognized), the converter component 1130 or another component can inject code to facilitate efficient and proper execution. Rules coded into the converter component 1130 or other component indicates what must be done to implement the desired functionality and identify locations where the code is to be injected or where other operations are to be carried out. Injected code typically includes added statements, metadata, or other elements at one or more locations, but this term can also include changing, deleting, or otherwise modifying existing source code. Injected code can be stored as one or more templates or in some other form. In addition, it should be appreciated that symbol table manipulations and parse tree transformations can take place.

Based on the symbol table 1160 and the parse tree 1170, a back-end component 1140 can translate the intermediate representation into output code. The back-end component 1140 converts the intermediate representation into instructions executable in or by a target processor, into memory allocations for variables, and so forth. The output code can be executable by a real processor, but the invention also contemplates output code that is executable by a virtual processor.

Furthermore, the front-end component 1120 and the back end component 1140 can perform additional functions, such as code optimization, and can perform the described operations as a single phase or in multiple phases. Various other aspects of the components of compiler 1110 are conventional in nature and can be substituted with components performing equivalent functions. Additionally, at various stages of processing of the source code, an error checker component 1150 can check for errors such as errors in lexical structure, syntax errors, and even semantic errors. Upon detection error, checker component can halt compilation and generate a message indicative of the error.

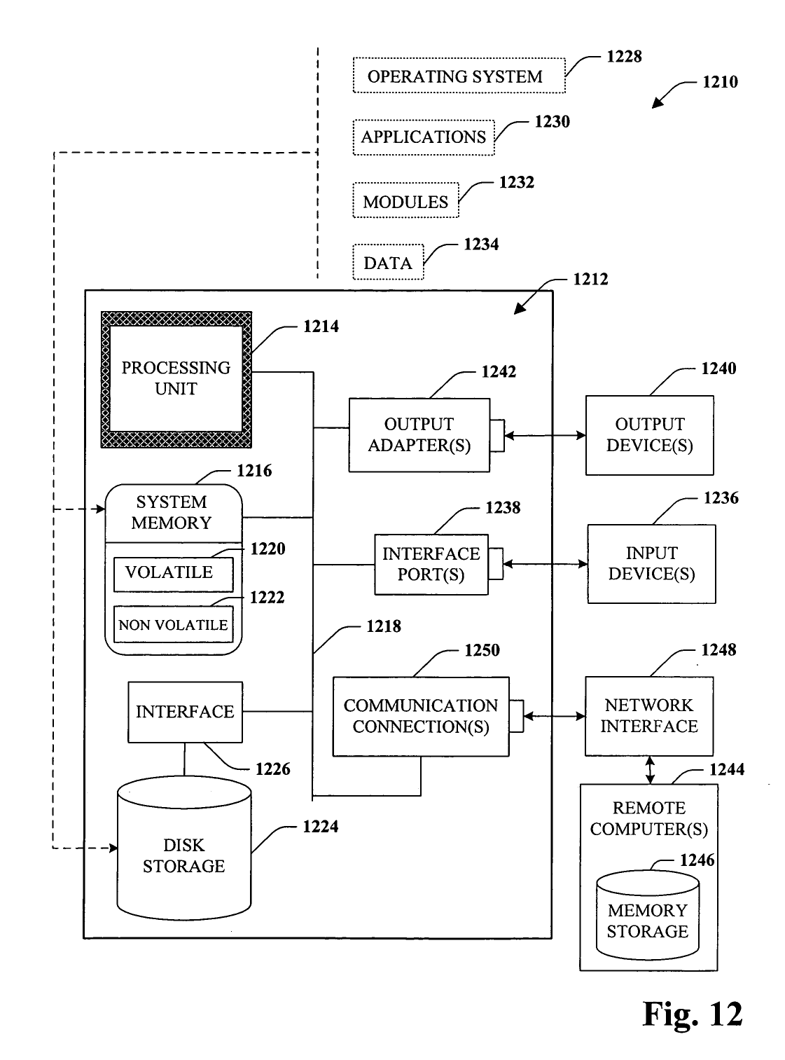

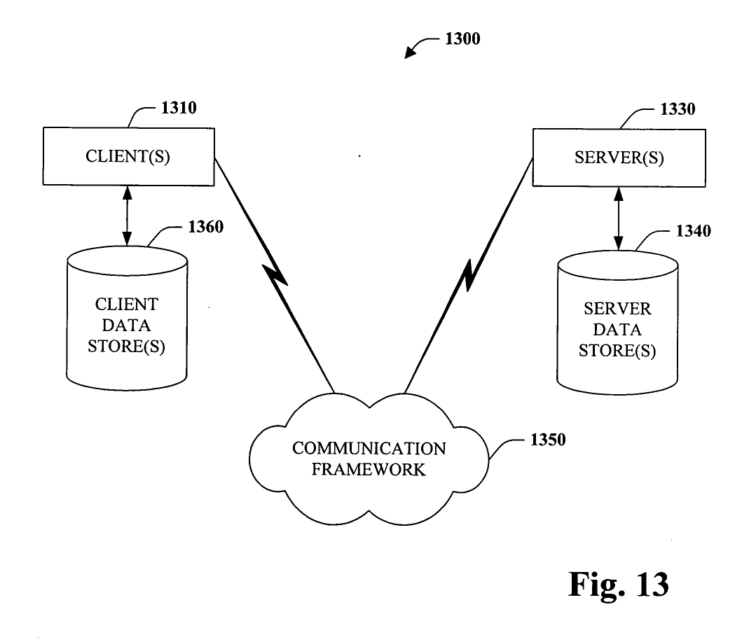

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216, and a system bus 1218. The system bus 1218 couples system components including, but not limited to, the system memory 1216 to the processing unit 1214. The processing unit 1214 can be any of various available microprocessors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example, disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212 and to output information from computer 1212 to an output device 1240. Output adapter 1242 is provided to illustrate that there are some output devices 1240 like displays (e.g., flat panel and CRT), speakers, and printers, among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems, power modems and DSL modems, ISDN adapters, and Ethernet cards or components.

FIG. 13 is a schematic block diagram of a sample-computing environment 1300 with which the present invention can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the present invention, for example. One possible communication between a client 1310 and a server 1330 may be in the form of a data packet adapted to be transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1130 are operatively connected to one or more server data store(s) 1340 that can be employed to store information local to the servers 1330.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. A multi-language programming system comprising:
an integrated development environment; and
a mixed language service component hosted by the development environment that interacts with a plurality of language service components to provide language specific information and services to the development environment to support multi-language program generation.

2. The system of claim 1, the mixed language service component includes a switch control component that delegates requests from the development environment to underlying languages service components based on context.

3. The system of claim 1, the mixed language service component includes a switch control component that coordinates switching of language service components.

4. The system of claim 3, the switch component coordinates recursive switching amongst a plurality of embedded language syntaxes.

5. The system of claim 4, the mixed language service component includes a data management component that stores language specific information that can be accessed by one or more of the language services components.

6. The system of claim 1, the language service components include a mechanism that signals transition to an embedded language.

7. The system of claim 2, the language service components include a mechanism to signal escape from an embedded language.

8. The system of claim 1, the language service components include components to at least one of scan, parse, type check and compile a specific language associated with the service component.

9. The system of claim 1, the language service components provide language specific information to the development environment to facilitate at least one of intelligent assistance, auto-completion, pretty print, and colorization.

10. A computer implemented mixed language program methodology comprising:
analyzing a programming language syntax;
switching a language service associated with a programming language upon detecting syntax of an alternate language;
reverting to a previous language service upon detecting termination of the language syntax; and
repeating the previous acts recursively until all language syntax as been analyzed.

11. The method of claim 10, further comprising executing at least one service of the language service.

12. The method of claim 11, executing at least one service of the language service comprises scanning language characters and identifying tokens.

13. The method of claim 11, executing at least one service of the language service comprises parsing the language syntax.

14. The method of claim 13, parsing the language syntax comprises generation of parse trees.

15. The method of claim 14, further comprising linking parse trees generated by the parsing services of different language services.

16. The method of claim 11, executing at least one service of the language service comprises type checking the language.

17. The method of claim 11, executing at least one service of the language service comprises providing an integrated development environment with language specific information to facilitate at least one of context assistance, formatting, auto-completion, and colorizing.

18. The method of claim 11, executing at least one service of the language services comprises generating code for execution.

19. A computer-implemented method of computer program development comprising:
receiving mixed-language code with two or more levels of embedding; and
providing language specific information and services to an integrated development environment to facilitate program generation.

20. A computer readable medium having stored thereon computer executable instructions for carrying out the method of claim 19.
